(19) United States
(12) Patent Application Publication
(10) Pub. No.: US 2023/0289551 A1
(43) Pub. Date: Sep. 14, 2023

(54) ELECTRONIC SEAL WITH A PASSIVE RFID CHIP, RFID READER AND RFID SYSTEM

(71) Applicant: ASIA SMART TAG CO., LTD., Taichung City (TW)

(72) Inventors: LIEN-FENG LIN, Taichung City (TW); YU-YING LIN, Taichung City (TW)

(21) Appl. No.: 18/181,808

(22) Filed: Mar. 10, 2023

(30) Foreign Application Priority Data
Mar. 11, 2022 (TW) 111109119

(51) Int. Cl. G06K 19/07; H04W 4/80; G06K 7/00; G06K 19/04

(52) U.S. Cl. CPC G06K 19/0723; G06K 7/0008; G06K 19/041; H04W 4/80

(57) ABSTRACT

An electronic seal system includes an electronic seal and a RFID reader. A passive RFID chip in the electronic seal has a configuration word and a seal state identification code inside. The value of the configuration word changes according to the state of the state configuration pins of the passive RFID chip. The state of the configuration pins is determined by the state of a bolt of the electronic seal. The RFID reader rewrites the seal state identification code according to the configuration word and the seal state identification code read by the RFID reader.

### BACKGROUND OF INVENTION

### Field of Invention

The invention relates to a seal, and more particularly, to an electronic seal which includes a passive RFID chip, a RFID reader and an electronic seal system.

### Related Prior Art

In recent years, a variety of designs for electronic seal with a passive RFID chip within has been developed, such as Taiwan Patent Nos. I292007, I322217, and I333018, and Taiwan Publication No. 201221740 and Taiwan Utility Model No. M392527.

However, most RFID antenna of the conventional electronic seal extends through the bolt member or the cable, so that when the bolt member or the cable is cut, the antenna is cut as well, and thus preventing an RFID reader from reading an identification code in the passive RFID chip. As a result, a user is able to determine whether the bolt member or the cable has been cut according to whether or not the RFID reader has read the memory code.

The aforementioned Taiwan Publication No. 201221740 disclosed a method for determining whether the bolt member or the cable has been cut, more specifically, the RFID chip it uses has a memory code, however, there are only two values in the memory code, so the RFID reader is only able to use it to indicate two states, namely, when the bolt member is inserted into the locking body, and when the bolt member is cut. the RFID reader is unable to detect other states such as when the bolt member is not inserted into the locking body, etc.

### SUMMARY OF THE INVENTION

In view of the drawbacks associated with the prior art, the present invention provides an electronic seal comprises of a passive RFID chip and an antenna, the passive RFID chip having two configuration pins and two antenna pins connected to the anntena, the passive RDIF chip further stores a configuration word and a memory code, wherein the value of the configuration word changes according to the electrical state of the two configuration pins, and the memory code is determined by a configuration word and a memory code read by a RFID reader.

The present invention further provides a RFID reader capable of reading and rewriting the value of a memory code of an electronic seal, the memory code is stored in a passive RFID chip, the passive RFID chip stores a configuration word, wherein the RFID reader is capable of performing the following: assigning the memory code a first state value if the memory code is read as said first state value and the configuration word is read as a first configuration value; assigning the memory code a second state value if the memory code is read as said first state value and the configuration word is read as said second configuration value; and assigning the memory code a third state value if the memory code is read as said second state value and the configuration word is read as said first configuration value.

In a preferred embodiment, the RFID reader of the present invention will rewrite the memory code as a fourth state value when the memory code is read as said third state value and the configuration word is read as said second configuration value.

The present invention further provides an electronic seal system that includes any one of the aforementioned electronic seals, and any one of the aforementioned RFID readers.

### BRIEF DESCRIPTION OF THE DRAWINGS

FIG. 1 is a perspective view of the electronic seal in accordance with a preferred embodiment of the present invention;

FIG. 2 is an exploded view of the electronic seal in accordance with a preferred embodiment of the present invention (the second housing 12 of FIG. 1 is omitted);

FIG. 3 is a partial cross-sectional view of the socket 11 in accordance with a preferred embodiment of the present invention;

FIG. 4 is a cross-sectional view of the socket with a fastener and a state change mechanism disposed therein in accordance with a preferred embodiment of the present invention;

FIG. 5 is a perspective view of the first second housing 12 and a circuit component 16 in accordance with a preferred embodiment of the present invention;

FIG. 6 is cross-sectional view of a bolt 2 in accordance with a preferred embodiment of the present invention;

FIG. 7 is a cross-sectional view of the preferred embodiment of the present invention in a fastened state;

FIG. 8 is a cross-sectional view of the preferred embodiment of the present invention in a cut state;

FIG. 9 shows the process of a memory code of the preferred embodiment of the present invention being rewritten;

FIG. 10 is a correspondence table of the memory code and the seal state of the preferred embodiment of the present invention;

FIGS. 11 to 13 are the schematic diagrams showing the change of state of the two conductive elements 162 of the preferred embodiment of the present invention;

FIGS. 14 to 16 are schematic diagrams showing the change of state of the two conductive elements 162 in another preferred embodiment of the present invention.

### DETAILED DESCRIPTION

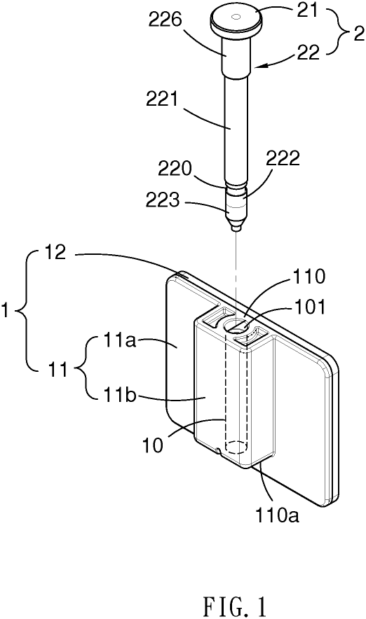

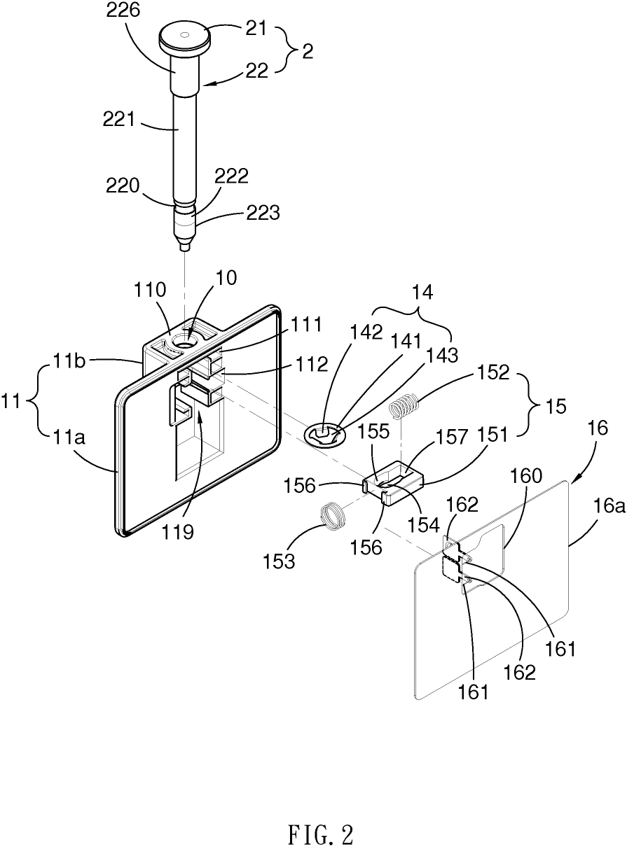

The electronic seal system of the present invention includes an electronic seal and a RFID reader (not shown in the drawings). In FIGS. 1 and 2, the electronic seal of the present invention includes a locking body 1, a bolt 2, and a fastener 14 configured on the locking body 1, a state change mechanism 15, two conductive elements 162, and a circuit component 16.

The locking body 1 is preferably made of hard plastic, and includes a first housing 11 and a second housing 12 that can be coupled together. The first housing 11 has a frame 11a and a socket 11b formed by the frame 11a protruding forward. The socket 1b has an insert slot 10, an entrance 101 of the insert slot 10 is located on the top surface 110 of the socket 11b, and the insert slot 10 extends downward from the entrance 101 to a length, but not does not penetrate a bottom surface 110a of the socket 11b. However, the insert slot 10 can also penetrate the bottom surface 110a if desired.

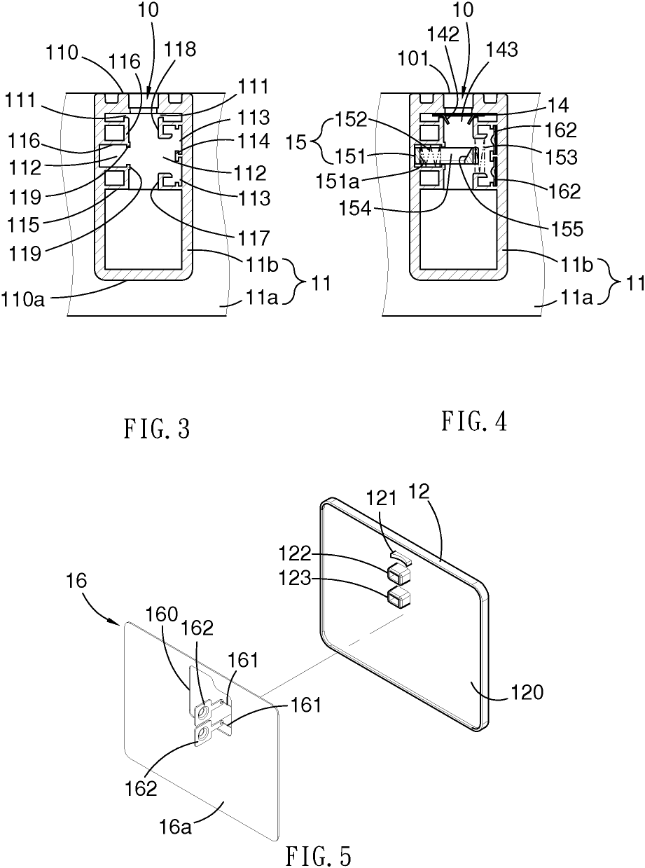

As shown in FIGS. 2-3, the interior of the socket 1 of the housing 1 has a first chamber 111 located below the insert slot 10, a second chamber 112 located below the first chamber 111, and two third chambers located on a side of the second chamber 112. The first chamber 111 and the second chamber 112 are in contact and in communication with each other, and the two third chambers 113 are in communication with the second chamber 112. These chambers 111~113 are formed by a plurality of dividers 114~118 formed inside the socket 11b, and as shown in FIGS. 3-4, the first chamber 111 accommodates the fastener 14, the second chamber 112 accommodates the state change mechanism 15, the two third chambers 113 each accommodates the two conductive elements 162 respectively, the two conductive elements 162 are divided by the divider 114 and spaced apart from each other, so that the two conductive elements 162 are usually at a non-conductive state.

As seen in FIG. 5, an inner surface 120 of the second housing 12 is formed with a plurality of projections 121~123 arranged at intervals, when the second housing is coupled to the first housing 11, these projections 121~123 are inserted into the socket 11b of the first housing 11 and adjacent to the insert slot 10 .

As shown in FIG. 2, the bolt 2 is preferably made of hard metal, such as iron or steel, which includes a head 21 and a shaft with an outer diameter smaller than the head 21. The shaft includes a main section 221, a mid-section 22 and a tail section 223, the main section 221 is connected to the head 21, the mid-section 222 has an annular groove 220 that is disposed between the main section 221 and the tail section 223.

The fastener is preferably made of elastic metals, such as spring steel, which includes a ring 141, a hollow 143 that is located inside the ring 141 and allows the tail section 223 of the bolt 2 to pass through, and a plurality of blocking sheets 142 protruding from the ring 141 through the hollow 143 and inclined downward. However, the structure of the fastener is not limited to the foregoing description, a c-shaped snap ring can also be used as the fastener 14.

The state change mechanism 15 includes a sliding block 151 and a conductive component 153. The sliding block 151 has a through hole 154 that allows the tail section 223 of the bolt to pass through and a bevel surface 155 adjacent to the through hole 154. The conductive component 153 is connected to the sliding block 151 and is able to move together with the sliding block 151. However, the conductive component 153 and the sliding block 151 can also be connected via other connecting method, and not limited to the foregoing.

Furthermore, the conductive component 153 may be elastic or non-elastic. In the preferred embodiment, the conductive component 153 is a conductive compressed spring, but not limited to so. When the sliding block 151 and the conductive components 153 reached the conducting position, the elastic conductive component 153 is pressed by the sliding block 153 to be in elastic contact with the two conductive elements 162.

In one preferred embodiment, as shown in FIG. 2 and FIG. 4, the state change mechanism 15 further includes a first compressed spring 152 in a receiving slot 157 located on the sliding block 151. One end of the first compressed spring 152 abuts against the two opposite flanges 119 on the socket 11b, and the other end of the first compression spring 152 abuts against an inner wall 151a of the sliding block 151. Therefore, in the course of the sliding block 151 moving from the original position to the conducting position, the first compressed spring 152 will be compressed by the inner wall 151a of the sliding block 151 and the two flanges 119 of the socket, thus accumulating elastic force. As a result, the sliding block 151 and the conductive components 153 are able to apply the accumulated elastic force of the first compressed spring 152 to return from the conducting position to the original position automatically. In the actual application, if the sliding block 151 does not need the function of automatically returning from the original position, the aforementioned receiving slot 157, the two flanges 119 and the first compressed spring 152 may be omitted.

As shown in FIG. 4, before the bolt is inserted into the insert slot 10 of the locking body 1, the hollow 143 of the ring of the fastener 14 aligns with the insert slot 10, and the state change mechanism remains in an original position, at this time, the through hole 154 of the sliding block 151 and the bevel surface 155 are facing the entrance 101 of the insert slot 10, the conductive component 153 is facing the two conductive elements 162, and keeping a distance from the two conductive elements without coming in contact with the conductive elements, so that the two conductive elements 162 are in a non-conductive state.

As shown in FIG. 7, when the bolt 2 has reached a predetermined depth during insertion into the insert slot 10 of the locking body 1, the tail section 223 of the bolt 2 first passed through the hollow 143 of the fastener 14, and then insert into the through hole 154 of the sliding block 151, and repal the bevel surface 155 next to the through hole 154 as it passes through the through hole 154, so that the sliding block 151 and the conductive component 153 move together from the original position as shown in FIG. 4 to a conducting position shown in FIG. 7, at this time, the conductive component 153 contacts the two conductive elements 162, so that the two conductive elements 162 enter into a conducting state. Meanwhile, the tail section 223 of the bolt 2 reaches the predetermined depth, and the annular groove 220 of the mid-section 222 is inserted and pressed against by the blocking sheet 142 of the fastener 14, which caused the fastener to be firmly fastened by the bolt 2 and unable to pull away from the locking body 1, unless the fastener 14 is destroyed and loses its fastening function.

As above-described, the two conductive elements 162 of the electronic seal of the present invention have two states, the non-conducting state and the conducting state, respectively corresponding to a non-inserted state indicating “the bolt 2 has not been inserted into the locking body 1”, and an inserted state where “the bolt 2 has been inserted into the locking body 1”.

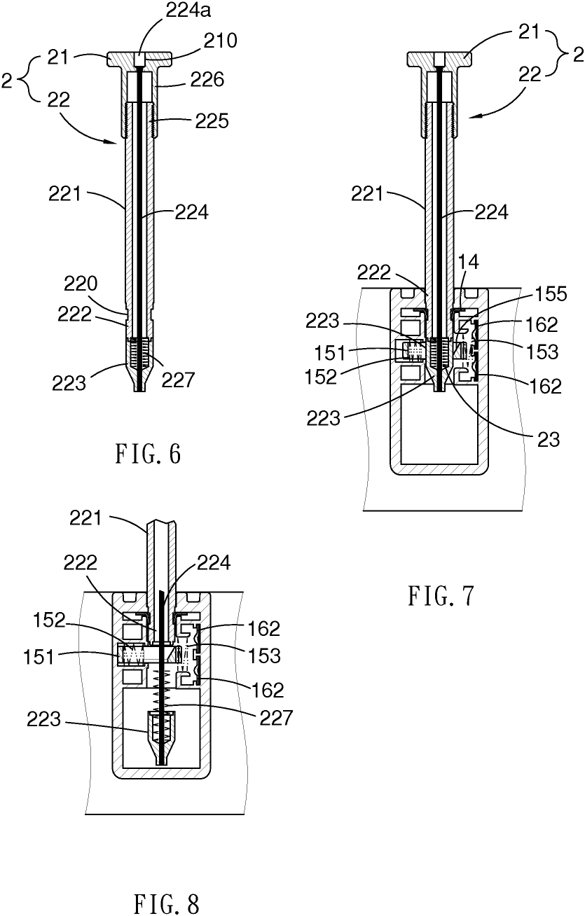

In one preferred embodiment, as shown in FIG. 6, the tail-section 223 of the shaft 22 of the bolt 2 can be configured to be ejectable, in particular, the bolt 2 includes a connecting wire 224 that passes through the shaft 22 and a second compressed spring 227 located in the tail-section 223 of the shaft 22. Two ends of the connecting wire 224 are respectively connected to the head 21 and the tail section 223 of the shaft 22. The mid-section 222 and the tail section 223 of the shaft 22 are tightly connected by the tightened connecting wire 224, the second compressed spring 227 is also compressed by the mid-section 222 and the tail section 223 of the shaft 22 via the tightened connecting wire 224, and thereby accumulates elastic force.

As shown in FIG. 7, when the tail section 223 of the shaft 22 moves the sliding block 151 and the conductive component 153 to the conducting position as described above, the tail section 223 will stay in the predetermined depth as its mid-section 222 is fastened by the fastener 14, and thereby blocking the sliding block 151, so that the sliding block 151 and the conductive component 153 remain in the conducting position and unable to return to the original position. Howevr, when the shaft 22 of the bolt 2 and the connecting wire 224 are cut off together, as shown in FIG. 8, the tail section 223 is quickly ejected downward by the elastic force accumulated by the second compressed spring 227, and thus departs from the sliding block 151, at the same time, the sliding block 151 and the conductive component 153 return to the original position by the elastic force accumulated by the first compressed spring 152, so that the two conductive elements 162 return from the conducting state to the non-conducting state.

In one preferred embodiment, the head 21 has a concave 210, one end of the connecting wire 224 has a blocking portion 224a, the blocking portion 224a is located inside the concave 210 and is blocked by a bottom of the concave so that it cannot enter into the shaft 221. This is just one of the ways for the end of the connecting wire 224 to connect to the head 21, the other end of the connecting wire 224 could also be connected to the tail section 223 in the same manner. However, in the preferred embodiment, the other end of the connecting wire 224 is directly clamped to a bottom end of the tail section 223. In any case, the way the connecting wire 224 and the head 21 are connected is not limited to the aforementioned, neither is the way the connecting wire 224 and the tail section 223 are connected.

Moreover, as further shown in FIG. 6, the main section 221 of the shaft 22 near the head 21 is configured to an outer rod 226 coupled to an inner rod 225, and the outer rod 226 is connected to the head 21, more specifically, the outer rod 226 and the head 21 are integrally formed. However, the the outer rod 226 and the inner rod 225 could also be integrally formed, that is, the head 21 to the mid-section 222 of the shaft 22 could all be integrally formed.

With the configuration such as the ejectable tail section 223, and the sliding block 151 and the conductive component 153 that can automatically return to the original position, in addition to the two aforementioned states, the two conductive elements 162 of the electronic seal of the present invention further comprises a third state where they return from the conducting state to the non-conducting state, and the third state indicates a cut off state where “the bolt 2 being cut off after being inserted into the locking body 1”. In practice, if only the un-inserted state and the inserted state are needed, then any corresponding mechanism (such as the aforementioned connecting wire 224 and the second compressed spring 227, etc) related to the cut off state can be omitted.

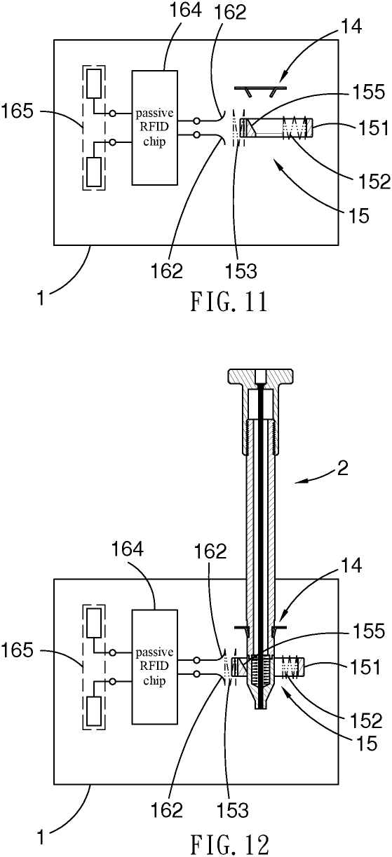

As shown in FIGS. 2 and 5, the circuilt component 16 includes a passive RFID chip 164 (see FIG. 11), an antenna 165 (see FIG. 11) of the passive RFID chip 164, and the two conductive wires 161 of the two conductive elements 162 coupled to the the passive RFID chip 164. The passive RFID chip 164 matches with the antenna 165, and the antenna 165 is preferably made of a printed wire printed on a circuit board 16a, such as a printed planar dipole antenna. The passive RFID chip 164 is welded to the pin of the antenna 165. The circuit board 16a can be a flexible printed circuit board or a rigid printed circuit board. Moreover, the antenna can also be made of enamel coated copper wire with insulating coating formed on the surface, then the aforementioned circuit board 16a is not needed.

The passive RFID chip is preferably selected from NXP Semiconductors’ UCODE G2iL SL3S1203, UCODE G2iL+ SL3S1213, UCODE G2iM SL3S1003 or UCODE G2iM+ SL3S101 RFID chip, but not limited to so. Regardless of the selection, the selected passive RFID chip has two antenna pins and two configuration pins, the two antenna pins are coupled to the antenna 165, the two configuration pins are respectively coupled to the two conductive wires 161. Thus, the value of a configuration word pre-stored in a storage location of the passive RFID chip 164 can be changed according to the states of the two conductive wires 161.In particular, the configuration word is initially preset as a first configuration value (such as 0) to point out that the two configuration pins are not conducting (for example, the two configuration pins are in an open state). However, when the two configuration pins are conducting (for example, the two configuration pins are short-circuited), the passive RFID chip 164 will change the value of the configuration word into a second configuration value (such as 1) different from the first configuration value to indicate that the two configuration pins are conducting. If the two configuration pins changes from conducting to not conducting, the passive RFID chip 164 will change the value of the configuration word to the first configuration value.

In one preferred embodiment, when the two conductive elements 162 are at the conducting state, the two configuration pins changes from a short-circuit state and switch to conducting, thereby the passive RFID chip 164 will change the value of the configuration word to the second configuration value (1). Once the two configuration pins changes from conducting to not conducting, the passive RFID chip 164 will change the configuration word to the first configuration value (0). In short, the value of the configuration word of the passive RFID chip 164 will change correspondingly to the state of the two configuration pins to either the first configuration value or the second configuration value.

It should be pointed out that the passive RFID chip 164 is usually without power supply, therefore, the change of the value of the configuration word is only carried out when it is read by the aforementioned RFID reader. In one preferred embodiment, when the RFID reader reads the circuit component 16 inside the electronic seal of the present invention, the passive RFID chip 164 receives transmitted radio frequency (RF) signal transmitted from the RFID reader, and obtains power supply from the RF signal conversion, and to use the power supply to change the value of the configuration word, at the same time, the passive RFID chip 164 sends the configuration word and a identification code to the RFID reader. The identification code is pre-stored in another storage location of the passive RFID chip 164, and it can be pre-programmed in the other storage location after being customized by a user.

Once the RFID reader receives the configuration word and the identification code, it will then displays a status description corresponding to the value of the configuration word, and displays the identification code. For example, if the configuration word and the identification code received by the RFID reader are 0 and 12345678 respectively, then the message such as “status description: bolt un-inserted” and “identification code: 12345678” will be displayed. If the configuration word and the identification code received by the RFID reader are 1 and 12345678 respectively, then the message such as “status description: bolt inserted” and “identification code: 12345678” will be displayed. Hence, no only will an inspector of the RFID reader obtained the identification code of the electronic seal, and also know whether it is currently in the un-inserted state or inserted state.

Furthermore, the circuit component 16 can be changed to another configuration, so that the RFID reader is able to read and display the cut-off state of the electronic seal, and even read and display a post cut-off forced conducting state. The post cut-off forced conducting state refers to when the two conductive elements 162 are forced to switch from the non-conducting state to the conducting state by illegal means when the bolt 2 is in the cut-off state (see FIG. 8).

More specifically, in addition to pre-storing the aforemtioned configuration word and identification code, the RFID chip 164 of the the circuit component 16 further pre-stores a memory code, and the RFID reader can be configured to read the memory code, the configuration word and the identification code of the passive RFID chip 164, and to rewrite the value of the identification code according to the value of the identification code and the value of the configuration word read, and to display the identification code and a status description, the content of the status description is determined according to the value of the memory code.

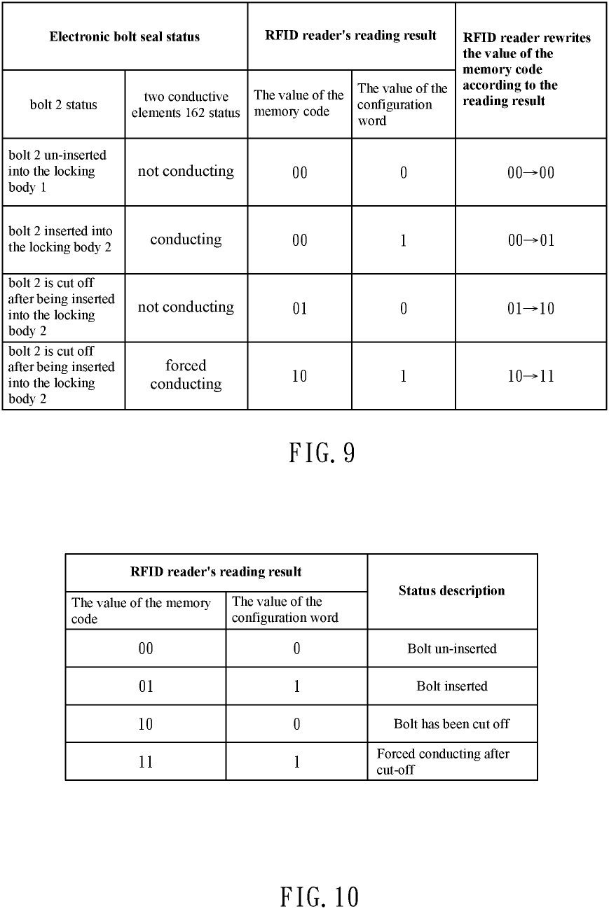

The change of the value of the configuration word, and the reading of the configuration word and the identification code are as described above and therefore not repeated here. As for the memory code, its initial value is preset as a first state value (such as 00), the change of the value of the memory code is described below in conjunction with FIGS. 9 and 10.

Before the bolt 2 is inserted into the locking body 1 so that the two conductive elements 162 are still in the non-conducting state, as described above, the value of the configuration word is the first configuration value (0), the value of the memory code is the first state value (00), thus the value of the memory code and the configuration word ready by the RFID reader are the first state value (00) and the first configuration value (0) respectively, accordingly, the value of the memory code is maintained as the first state value by the the RFID reader. Unless the state of the electronic seal changes again, otherwise, the RFID reader will subsequently read the first state value (00) and the second configuration value (0), consequently, the RFID reader will display a corresponding status description, such as “status description: the bolt is not inserted”, and surely, as mentioned above, the RFID reader will also display the identification code it has read.

When the bolt 2 is inserted into the locking body 1 and causing the two conductive components 162 to move from the non-conducting state to the conducting state, as aforementioned, the memory code will be changed to the second figuration value (1) by the passive RFID chip 164, but the value of the memory code remains as the first state value (00), the value of the memory code and the configuration word read by the RFID reader are the first state value (00) and the second configuration value (1) respectively, consequently, the RFID reader will rewrite the value of the memory code into a second state value (such as 01) by its writing function. Once the value of the memory code is rewritten to the second state value (01), unless the state of the electronic seal changes again, otherwise, the RFID reader will subsequently read the second state value (01) and the second configuration value (1), consequently, the RFID reader will display a corresponding status description, such as “status description: the bolt is inserted”, and surely, as mentioned above, the RFID reader will also display the identification code it has read.

When the bolt 2 is cut off after being inserted into the locking body 1 and causing the two conductive elements 162 to return from the conducting state to the non-conducting state, as mentioned above, the memory code will be changed back to the first configuration word (0) by the passive RFID chip 164, but the value of the memory code remains the second state value (01), so that the value of the memory code and the configuration word read by the RFID reader are the first state value (01) and the first configuration value (0) respectively, consequently, the RFID reader will rewrite the value of the memory code into a third state value (such as 10) by its writing function. Once the value of the memory code is rewritten to the third state value (10), unless the state of the electronic seal changes again, otherwise, the RFID reader will subsequently read the third state value (10) and the first configuration value (0), consequently, the RFID reader will display a corresponding status description, such as “status description: the bolt is cut off”, and surely, as mentioned above, the RFID reader will also display the identification code it has read.

If after the bolt 2 is cut off, the two conductive elements 162 are forced to re-entered the conducting state from the non-conducting state, then as mentioned above, the memory code will be rewritten to the second configuration value (1) by the passive RFID chip 164, and the value of the memory code remains the thid state value (10), so that the value of the memory code and the configuration word read by the RFID reader are the third state value (10) and the second configuration value (1) respectively, consequently, the RFID reader will rewrite the value of the memory code into a fourth state value (such as 11) by its writing function. Once the value of the memory code is rewritten to the fourth state value (11), unless the state of the electronic seal changes again, otherwise, the RFID reader will subsequently read the fourth state value (11) and the second configuration value (1), consequently, the RFID reader will display a corresponding status description, such as “status description: the bolt is forced conducting after cut-off”, and surely, as mentioned above, the RFID reader will also display the identification code it has read.

The change of the value of the ememory code can be seen from the aforementioned description, as seen in FIG. 10, the memory code has four different state values (such as 00~11) each corresponding to the four states of the electronic seal respectively, namely, the first state value (00) indicates the non-inserted state of the electronic seal (meaning the bolt 2 is not inserted into the locking body 1), the second state value (01) indicates the inserted state of the electronic seal (meaning the bolt is inserted into the locking body 1), the third state value (10) indicated the cut-off state of the electronic seal (meaning the bolt 2 is cut off after being inserted into the locking body 1), the fourth state value (11) indicates the post cut-off forced conducting state of the electronic seal (meaning the two conductive elements 162 are forced to conduct after the bolt 2 has been cut off).

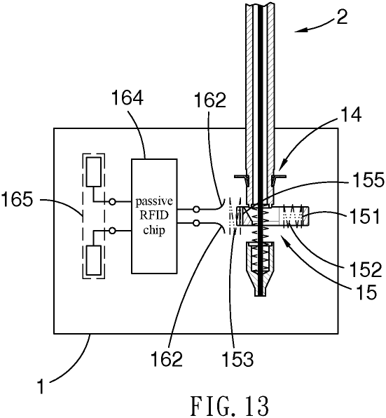

FIGS. 11 to 13 show the state change of the two conductive elements 162 of the above-mentioned preferred embodiment, in conjunction with the above-description, FIG. 11 shows the two conductive elements 162 are initially in a non-conducting state (the first state) that is not conducted by the state change mechanism 15, it is until the the bolt 2 is inserted into the locking body 1 will the state change mechanism 15 being conducting (the second state), as shown in FIG. 12; when the bolt 2 is cut off after being inserted into the locking body 1, as shown in FIG. 13, the two conductive elements 162 will automatically return to the non-conducting state (the first state).

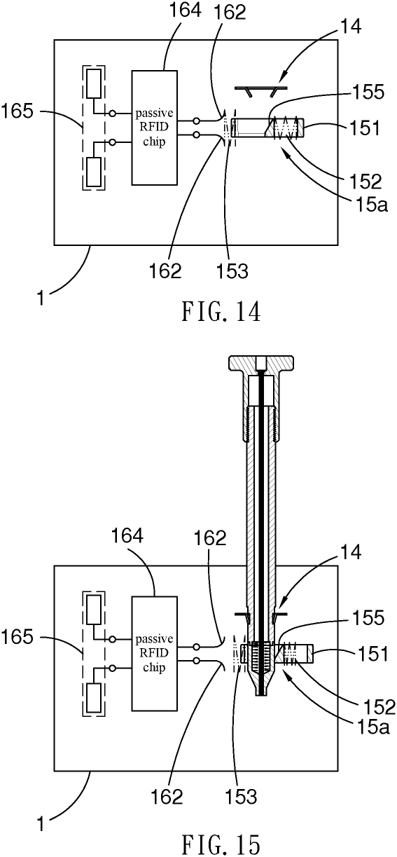

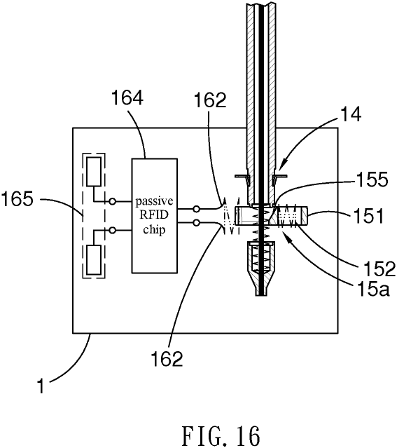

However, in another preferred embodiment that is similar to the aforemtioned preferred embodiment, the foregoing configurations are changed to as shown in FIGS. 14 to 16, namely: as shown in FIG. 14, the two conductive elementions 162 is initially contacted by the state change mechanism 15a and are in a conducting state (the first state), until the bolt 2 is inserted into the locking body 1 will the state change mechanism 15a be pushed by the bolt 2 and depart from the two conductive elements 162, as shown in FIG. 15, causing the two conductive elements 162 to be in the non-conducting state (the second state); and when the bolt 2 is cut off after being inserted into the locking body 1, as shown in FIG. 16, the two conductive elements 162 will return to the conducting state (the first state).

It should be pointed out that the aforementioned bolt 2 could also be a flexible or bendable cable or steel cable, as disclosed in Taiwan Patent Publication No. 201221740 and Taiwan Patent No. M392527.

Regardless of how the mechanism of the electronic seal of the present invention is configured, as long as it able to form the above-mentioned four states, it can be used in conjunction with above-mentioned passive RFID chip 164, the antenna 165 and the RFID reader to carry out the aformentioned operation, so that the RFID reader is able to read three or four different state values of the memory code which represent the foregoing three or four states of the electronic seal respectively.

In view of the above, the antenna 165 and the passive RFID chip 164 of the present invention is always connected and able to be read by the RFID reader, that is, the RFID reader can always read the identification code, and/or the configuration code, and/or the memory code saved in the passive RFID chip 164, regardless of which state the electronic seal of the present invention is in.

Moreover, with the above-mentioned configuration of the configuration word, the state of the electronic seal of the present invention (such as the non-inserted state and inserted state) can be read by the RFID reader. In some embodiments, with the above-mentioned configuration of the configuration word and the memory code, the state of the electronic seal of the present invention (such as the cut-off state, and the post cut-off forced conducting state) can also be read by the RFID reader.

What is claimed is:

1. An electronic seal comprising a passive RFID chip and an antenna, the passive RFID chip having two configuration pins and two antenna pins connected to the anntena, the passive RDIF chip storing a configuration word and a memory code, wherein a value of the configuration word changes according to the electrical state of the two configuration pins, and the memory code is determined by the configuration word and the memory code after being read by a RFID reader.

2. The electronic seal according to claim 1 further comprising:
a bolt;
a locking body having an insert slot to be inserted by the bolt;
a fastener configured on the locking body and able to fasten the bolt when the bolt has reached a predetermined depth during insertion into the insert slot; and
two conductive elements configured on the locking body and spaced apart;
a state change mechanism configured on the locking body and able to move relative to the locking body, wherein the state change mechanism is normally located at an original position keeping a distance from the two conductive elements, the state change mechanism being pushed by the bolt from the original position to a conducting position where the two conductive elements are conducted to each other after the bolt is inserted into the locking body and fastened by the fastener; wherein the two configuration pins of the passive RFID chip are respectively coupled to the two conductive elements.

3. The electronic seal according to claim 2, wherein the state change mechanism further comprises a first compressed spring located in a receiving slot of the sliding block, one end of the first compressed spring abutting against two opposite flanges of the locking body, the other end of the first compressed spring abutting against an inner wall of the sliding block.

4. The electronic seal according to claim 2, wherein the state change mechanism comprises:
a sliding block located below the fastener and comprising a through hole that allows a tail section of the bolt to pass through and a bevel surface adjacent to the through hole, the through hole and the bevel surface directly facing an entrance of the insert slot; and
a conductive component connected to the sliding block and capable of moving from the original position to the conducting position together with the sliding block to be connected with the two conductive elements.

5. The electronic seal according to claim 4, wherein the state change mechanism further comprises a first compressed spring located in a receiving slot of the sliding block, one end of the first compressed spring abutting against two opposite flanges of the locking body, the other end of the first compressed spring abutting against an inner wall of the sliding block.

6. The electronic seal according to claim 1, wherein the passive RFID chip stores a configuration word, a value of the configuration word being able to be changed according to a state of the two conductive elements and sent to a RFID reader when the passive RFID chip is read by the RFID reader, wherein the configuration word corresponds to a first value when the two conductive elements are not conducted to each other and corresponds to a second value different from the first value when the two conductive elements are conducted to each other.

7. The electronic seal according to claim 1 comprising a bolt and a socket, the bolt being capable of being inserted into the socket, the socket comprising the passive RFID chip, the antenna, two conductive elements and a state change mechanism, the antenna being coupled to the antenna pin of the passive RFID chip, the two conductive elements being respectively coupled to the two configuration pins of the RFID chip, wherein when the bolt is not inserted into the socket, the state change mechanism stays in an original position, so that the two conductive elements remain in a first state; when the bolt is inserted into the socket, the state change mechanism is moved to another position by the bolt, so that the two conductive elements change into a second state; and
when the bolt inserted in the socket is cut, the state change mechanism returns to the original position, so that the two conductive elements return to the first state.

8. A RFID reader capable of reading and rewriting a value of a memory code of an electronic seal, the memory code being stored in a passive RFID chip, the passive RFID chip storing a configuration word,
wherein when the value of the memory code read by the RFID reader is a first state value and the value of the configuration word read by the RFID reader is a first configuration value, the value of the memory code is maintained as the first state value by the RFID reader;
wherein when the value of the memory code read by the RFID reader is the first state value and the value of the configuration word read by the RFID reader is a second configuration value, the value of the memory code is changed to a second state value by the RFID reader; wherein when the value of the memory code read by the RFID reader is the first state value and the value of the configuration word read by the RFID reader is a second configuration value, the value of the memory code is changed to a third state value by the RFID reader.

9. The RFID reader according to claim 8, wherein when the value of the memory code read by the RFID reader is the first state value and the value of the configuration word read by the RFID reader is a second configuration value, the value of the memory code is changed to a fourth state value by the RFID reader.

10. An electronic seal system including an electronic seal as recited in claim 1, and a RFID reader 9capable of reading and rewriting a value of a memory code of an electronic seal, the memory code being stored in a passive RFID chip, the passive RFID chip storing a configuration word,
wherein when the value of the memory code read by the RFID reader is a first state value and the value of the configuration word read by the RFID reader is a first configuration value, the value of the memory code is maintained as the first state value by the RFID reader;
wherein when the value of the memory code read by the RFID reader is the first state value and the value of the configuration word read by the RFID reader is a second configuration value, the value of the memory code is changed to a second state value by the RFID reader;
wherein when the value of the memory code read by the RFID reader is the first state value and the value of the configuration word read by the RFID reader is a second configuration value, the value of the memory code is changed to a third state value by the RFID reader.
